(19) United States
(12) Patent Application Publication
(10) Pub. No.: US 2015/0078706 A1
(43) Pub. Date: Mar. 19, 2015

(54) INTEGRATED OPTICAL LENS MODULE

(71) Applicant: HON HAI PRECISION INDUSTRY CO., LTD., New Taipei (TW)

(72) Inventors: SHUAI-HUI HUANG, Kunshan (CN); QING-MAN ZHU, Kunshan (CN); LI-SHING HOU, New Taipei (TW); JERRY WU, Irvine, CA (US)

(21) Appl. No.: 14/488,546

(22) Filed: Sep. 17, 2014

(30) Foreign Application Priority Data
Sep. 17, 2013 (CN) 201310423588.7

(51) Int. Cl. G02B 6/42

(52) U.S. Cl. CPC G02B 6/4206; G02B 6/4204; G02B 2006/12085
USPC 385/33

(57) ABSTRACT

An integrated optical lens module (100) adapted for coupling an optical medium (200) and an optical-electrical module includes a body, a reflective mirror (10) for changing a transmitting direction of an optical beam, a lens (20) disposed at a bottom of the body, and a mounting hole (30) for receiving an optical medium. There is no lens disposed between the mounting hole and the reflective mirror.

### BACKGROUND OF THE INVENTION

1. Field of the Invention

The present invention relates to an integrated optical lens module, and more particularly to an integrated optical lens module used in an active optical cable assembly.

2. Description of Related Arts

U.S. Pat. No. 7,371,014, issued on May 13, 2008 to Willis et al., discloses an active optical cable assembly. The active optical cable assembly comprises an optical-electrical connector and an optical cable coupling with the connector. The connector comprises a printed circuit board, an optical-electrical module mounted on the printed circuit board, a lens module for optically coupling with the optical-electrical module, and a ferrule for coupling the optical cable with the lens module. The lens module and the ferrule are separately manufactured by two sets of moulds. Then the ferrule is assembled to the lens module.

U.S. Pat. No. 7,329,054, issued on Feb. 12, 2008 to Epitaux et al., discloses an optical transceiver comprising a multi-port lens assembly. The lens assembly comprises a body defining a plurality of grooves on one side thereof for receiving optical fibers, a receiving room on an opposite side thereof for receiving electro-optical converters, a total internal reflection interface 66 disposed in the light path between the optical fibers and the receiving room to reflect beams, a first collimating lens (or a first focusing lens) disposed between the optical fibers and the reflection interface, and a second focusing lens (or a second collimating lens) disposed between the reflection interface and the convertors. Stopping features or protrusions are provided to position exposed front ends of the optical fibers in a longitudinally desired location. The collimating lens and the focusing lens collimate and focus light beams.

U.S. Publication No. 2012/0093462, published on Apr. 19, 2012 to Childers et al., discloses a unitary multi-fiber ferrule with integrated lenses.

U.S. Publication No. 2012/0189252, published on Jul. 26, 2012 to Bhagavatula et al., discloses a receptacle ferrule assembly for a fiber optic receptacle connector. The receptacle ferrule assembly comprises a ferrule body and two gradient index lenses at a front end of the ferrule body. The receptacle ferrule assembly engages a plug ferrule assembly that supports two optical fibers and two plug gradient index lenses.

An improved optical lens module is desired to offer advantages over the related art.

### SUMMARY OF THE INVENTION

An object of the present invention is to provide a low-cost integrated optical lens module that is easy to assemble.

To achieve the above-mentioned object, an integrated optical lens module adapted for coupling an optical medium and an optical-electrical module comprises a body, a reflective mirror for changing a transmitting direction of an optical beam, a lens disposed at a bottom of the body, and a mounting hole for receiving an optical medium, wherein there is no lens disposed between the mounting hole and the reflective mirror.

According to the present invention, the reflective mirror is integrated with the lens that will reduce cost, assembly error, and increase coupling efficiency.

### BRIEF DESCRIPTION OF THE DRAWING

FIG. 1 is a perspective view of an integrated optical lens module in accordance with the present invention;

FIG. 2 is another perspective view the integrated optical lens module as shown in FIG. 1;

FIG. 3 is a cross sectional view of the integrated optical lens module taken along line 3-3 of FIG. 1; and

FIG. 4 is an optical signal transmitting trace in the integrated optical lens module as shown in FIG. 1.

### DETAILED DESCRIPTION OF THE PREFERRED EMBODIMENT

Reference will now be made in detail to a preferred embodiment of the present invention.

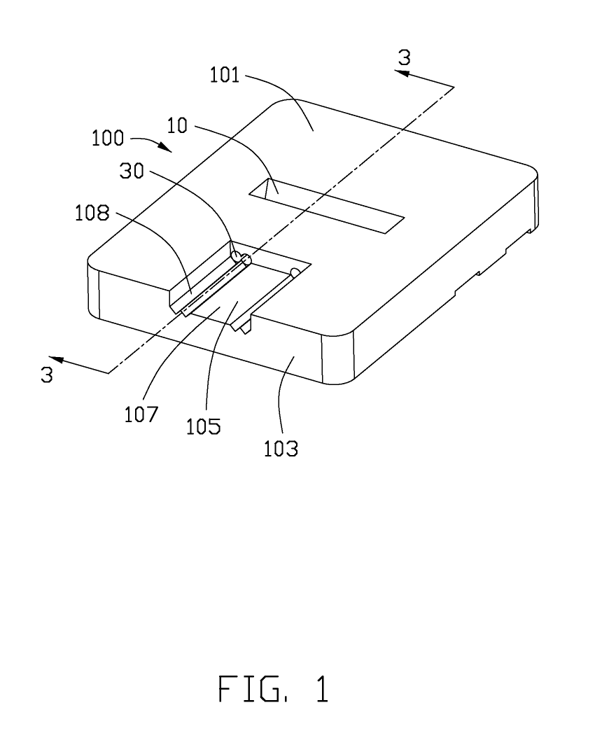

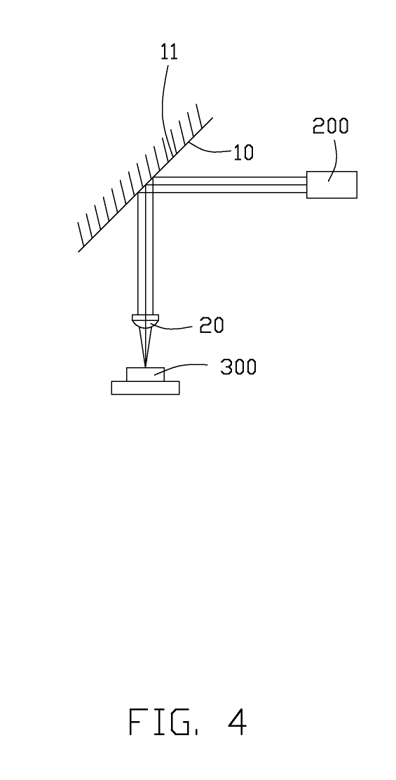

Referring to FIGS. 1 to 4, an integrated optical lens module 100 in accordance with the present invention is adapted for coupling an optical medium 200 and an optical-electrical module (not shown), comprising a body, a reflective mirror 10 for changing a transmitting direction of an optical beam, a lens 20 disposed at a bottom of the body and for coupling the optical beam from the reflective mirror 10, and a plurality of mounting holes 30 for receiving the optical medium. As shown in FIG. 4, the optical medium 200 may be optical fiber, polymer waveguide or other suitable material. The optical-electrical module may comprise a laser, such as VCSEL, for converting electrical signal to optical signal and a photodiode, such as PIN diode, for converting optical signal to electrical signal.

Referring to FIGS. 1 to 3, the body has a rectangular shape and comprises a top wall 101, a bottom wall 102 opposite to the top wall 101, a rear wall 103 connecting the top wall 101 and the bottom wall 102, and a front wall 104 opposite to the rear wall 103. The top wall 101 has an upper receiving portion 105 downwardly recessed and extending through the rear wall 103. The upper receiving portion 105 is in communication with the mounting holes 30. The bottom wall 102 defines a bottom receiving portion 106 upwardly recessed and extending through the front wall 104 for receiving the optical-electrical module, the lens exposed on the bottom receiving portion.

Referring to FIGS. 1, 3 and 4, the reflective mirror 10 has a reflective face 11 at 45 degrees relative to the extending direction of the mounting holes 30. A transmitting direction of an optical beam, therefore, is changed 90 degrees, when the optical beam is reflected by the reflective face 11.

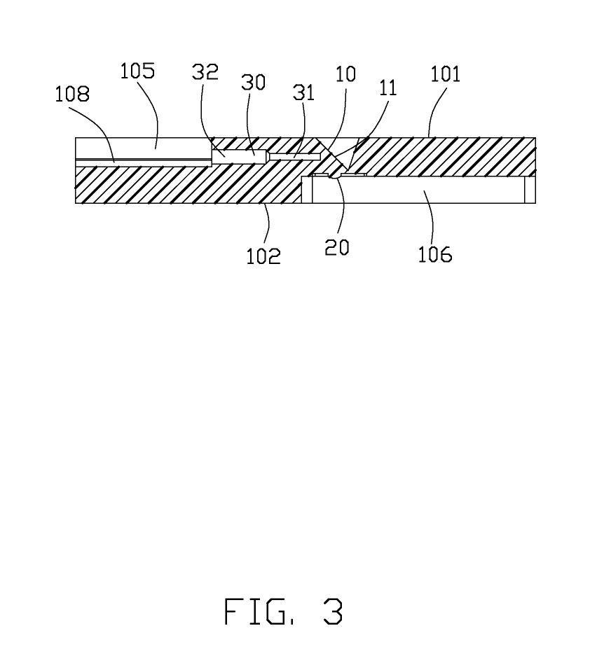

Referring to FIGS. 1 and 3, the mounting holes 30 extend along a rear to front direction and are arranged side by side along a transverse direction which is perpendicular to the rear to front direction. Each of the mounting holes 30 comprises a first portion 31 adjacent to the reflective mirror 10, and a second portion 32 connecting with the first portion 31. The first portion 31 has a radial dimension smaller than a radial dimension of the second portion 32. Each of the mounting holes 30 has a rounded cross section. Referring to FIG. 4, it can be seen that there is no lens disposed between the reflective mirror 10 and the lens 20, the optical beam directly coupling between the reflective mirror 10 and the optical medium 200.

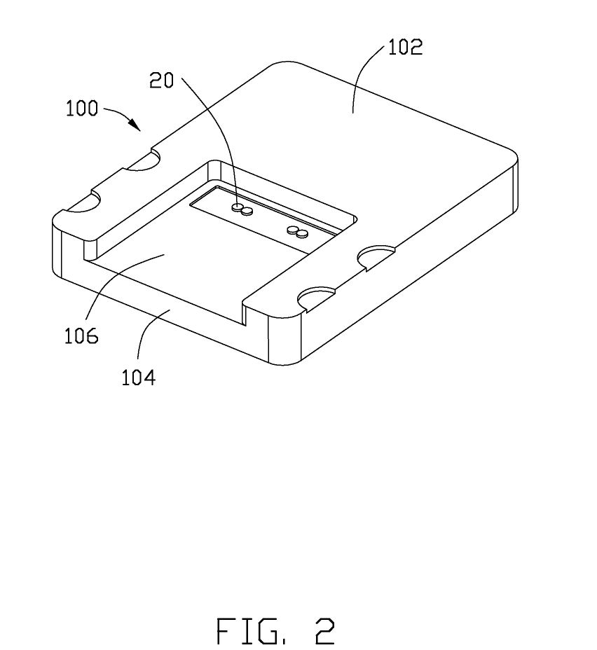

Referring to FIGS. 1 and 3, the upper receiving portion 105 is in communication with the mounting holes 30 for conveniently inserting the optical medium 200 thereinto along the rear to front direction. The upper receiving portion 105 comprises a bottom portion 107 defining a restrictive groove 108 in communication with the mounting hole 30. The restrictive groove 108 has a V-shaped cross section to restrict the optical medium 200. Referring to FIG. 2, the lens 20 is exposed on the bottom receiving portion 106 to optically couple with the optical-electrical module.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An integrated optical lens module adapted for coupling an optical medium and an optical-electrical module, comprising:
a body;
a reflective mirror for changing a transmitting direction of an optical beam;
a lens disposed at a bottom of the body; and
a mounting hole for receiving an optical medium;
wherein there is no lens disposed between the mounting hole and the reflective mirror.

2. The integrated optical lens module as recited in claim 1, wherein the body comprises a top wall, a bottom wall opposite to the top wall, a rear wall connecting the top wall and the bottom wall, and a front wall opposite to the rear wall, the top wall defining an upper receiving portion downwardly recessed and extending through the rear wall, the upper receiving portion being in communication with the mounting hole.

3. The integrated optical lens module as recited in claim 2, wherein the upper receiving portion comprises a bottom portion defining a restrictive groove in communication with the mounting hole.

4. The integrated optical lens module as recited in claim 3, wherein the restrictive groove has a V-shaped cross-section.

5. The integrated optical lens module as recited in claim 2, wherein the mounting hole comprises a first portion adjacent to the reflective mirror and a second portion connected with the first portion, the first portion having a radial dimension smaller than a radial dimension of the second portion.

6. The integrated optical lens module as recited in claim 2, wherein the bottom wall defines a bottom receiving portion upwardly recessed and extending through the front wall for receiving an optical-electrical module, the lens exposed on the bottom receiving portion.

7. The integrated optical lens module as recited in claim 1, wherein the reflective mirror has a reflective face at 45 degrees relative to an extending direction of the mounting hole.

8. The integrated optical lens module as recited in claim 1, wherein the mounting hole has a rounded cross-section.

9. The integrated optical lens module as recited in claim 1, wherein there are a plurality of mounting holes arranged side by side.

10. An integrated optical lens module adapted for coupling an optical medium and an optical-electrical module, comprising:
a monolithic body defining a lengthwise direction and a vertical direction perpendicular to each other;
a reflective mirror formed by removal of an upper portion of the body and extending in a forty-five degrees relative to the either one of said lengthwise direction and said vertical direction for changing a transmitting direction of an optical beam;
a lens disposed at a lower portion of the body and aligned with said reflective mirror in the vertical direction; and
a mounting hole extending along the lengthwise direction for receiving an optical medium; wherein
an inner end of the mounting hole is terminated before reaching the reflective mirror with a minor distance therebetween.

11. The integrated optical lens module as claimed in claim 10, wherein an axis of said mounting hole is pointed toward a center region of the reflective mirror, viewed in a transverse direction perpendicular to both said lengthwise direction and said vertical direction.

12. The integrated optical lens modules as claimed in claim 10, wherein the inner end is located within an area under the reflective mirror viewed in the vertical direction.

13. The integrated optical lens module as claimed in claim 10, wherein said lens is exposed in a bottom receiving portion which is exposed to an exterior in a bottom wall, and the mounting hole communicates and is aligned with a V-shaped groove in an upper receiving portion which is formed in the upper wall and exposed to the exterior.

14. The integrated optical lens module as claimed in claim 10, wherein no lens structure is formed between the end of the mounting hole and the reflective mirror.
